(19) United States
(12) Patent Application Publication
(10) Pub. No.: US 2015/0328659 A1
(43) Pub. Date: Nov. 19, 2015

(54) TIN OXIDE FILM AND MANUFACTURING METHOD OF THE SAME

(71) Applicant: INDUSTRIAL TECHNOLOGY RESEARCH INSTITUTE, Hsinchu (TW)

(72) Inventors: Yu-Chun CHEN, Taoyuan City (TW); Chin-Ching LIN, Taichung City (TW); En-Kuang WANG, Hsinchu City (TW); Mei-Ching CHIANG, Zhubei City (TW); Yi-Chen CHEN, Kaohsiung City (TW); Hung-Chou LIAO, Taoyuan City (TW)

(73) Assignee: INDUSTRIAL TECHNOLOGY RESEARCH INSTITUTE, Hsinchu (TW)

(21) Appl. No.: 14/655,112

(22) PCT Filed: Dec. 28, 2012
(86) PCT No.: PCT/CN2012/087835

§ 371 Date: Jun. 24, 2015

(51) Int. Cl. B05D 1/34; B05D 3/00; B05D 1/02

(52) U.S. Cl. CPC B05D 1/34; B05D 1/02; B05D 3/002

(57) ABSTRACT

A low-haze tin oxide film and a manufacturing method thereof are provided. The method includes: applying a mixed solution on a substrate and heating the substrate to form a tin oxide film. The mixed solution contains a tin source, an oxidizing agent, and a solvent.

This application is the 35 U.S.C. §371 national stage of PCT application PCT/CN2012/087835, filed Dec. 28, 2012, the disclosure of which is hereby incorporated by reference.

### TECHNICAL FIELD

The disclosure relates in general to a tin oxide film and a manufacturing method thereof, and more particularly to a tin oxide film having low haze and a manufacturing method thereof.

### BACKGROUND

As the global warming effect causes great climate changes around the world, freezing winter and sultry summer are more frequently seen, and the development of renewable energy and energy-saving technology has become more and more important. Apart from introducing more environmentally friendly building materials and renewable energy sources in the design of buildings, architects actively use more high-tech energy-saving building materials and apply green building space design, so that people can live comfortably even in a harsh environment. One of the most widely used high-tech building materials is energy-saving glass. Since ordinary windows are incapable of blocking sunlight from entering the building, sunlight will enter the building and make the interior temperature rise. Therefore, an energy-saving glass capable of blocking out sunlight and preventing heat energy from entering the building through window glass is developed, thereby reducing air conditioning usage inside the building and achieving energy-saving effect is provided.

Tin oxide film is an infrared blocking material commonly used in energy-saving glass. Although the tin oxide film is capable of blocking infrared light, the haze of the tin oxide film is still too high. Therefore, how to provide a tin oxide film capable of blocking infrared light and at the same time having low haze has become a prominent task for the industries.

### SUMMARY

The disclosure is directed to a tin oxide film and a manufacturing method thereof. By applying a mixed solution containing a tin source and an oxidizing agent on the substrate, the chance of nucleation of tin oxide on the surface of the substrate is enhanced, allowing a more accurate control over the ratio of the tin source to the oxidizing agent when the reaction is taking place, and a tin oxide film with low haze is formed accordingly.

According to one embodiment, a manufacturing method of a tin oxide film is provided. The manufacturing method of the tin oxide film includes: providing a mixed solution and a substrate, wherein the mixed solution includes a tin source, an oxidizing agent and a solvent; heating the substrate; and applying the mixed solution on the substrate to form the tin oxide film on the substrate.

According to another embodiment, a tin oxide film is provided. The tin oxide film has a haze with respect to visible light of lower than 3%, a film thickness, and a surface roughness. The surface roughness is a root mean square (RMS) surface roughness, and a ratio of the surface roughness to the film thickness is greater than 0.05.

According to a further embodiment, a tin oxide film is provided. The tin oxide film has a haze with respect to visible light of lower than 3%, and the X-ray diffraction spectrum of the tin oxide film has a (200) diffraction peak and a (110) diffraction peak of tin oxide, and a ratio of the integrated area of the (200) diffraction peak to the integrated area of the (110) diffraction peak is greater than 1.5.

### BRIEF DESCRIPTION OF THE DRAWINGS

FIG. 1 is a schematic diagram of a tin oxide film according to an embodiment of the disclosure.

FIG. 2 is an X-ray diffraction spectrum of a tin oxide film according to an embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In the embodiments of the present disclosure, By applying a mixed solution containing a tin source and an oxidizing agent on the substrate, the chance of nucleation of tin oxide on the surface of the substrate is enhanced, allowing a more accurate control over the ratio of the tin source to the oxidizing agent when the reaction is taking place, and a tin oxide film with low haze is formed accordingly.

Disclosed herein is a manufacturing method of a tin oxide film according to an embodiment of the present disclosure. However, the steps of the method are for exemplary and explanatory only, not for limiting the invention. It should be noted that the accompanying drawings are simplified, such that the embodiment of the disclosure can be more clearly described. Detailed structures of the disclosed embodiments are exemplary and explanatory only, and are not restrictive of the disclosed embodiments as claimed. Anyone who is skilled in the technology of the disclosure will be able to make proper modifications or variations to the structures and the steps of the disclosure.

Firstly, a mixed solution and a substrate are provided. In an embodiment, the mixed solution including a tin source, an oxidizing agent, and a solvent, and the tin source and the oxidizing agent are dissolved in the solvent. In the embodiment, the tin source includes such as one or any two of tin dichloride (SnCl₂), tin tetrachloride (SnCl₄), butyltin trichloride, dimethyltin dichloride, and tetramethyltin. The oxidizing agent includes such as either one or both of hydrogen peroxide and hypochlorous acid. The solvent includes such as at least one of water and ethanol. In the embodiment, the materials of the tin source, the oxidizing agent, and the solvent can be properly selected according to actual needs, and are not limited to the above exemplifications.

In the embodiment, the molar ratio of the tin source to the oxidizing agent is about 1:0.3 to 1:1.5.

Next, the substrate is heated, and the mixed solution is applied on the substrate.

In the embodiment, the substrate is heated at a temperature of such as 250-700° C. For example, the substrate is heated by a heater disposed on the other surface of the tin oxide film opposite to the substrate. In an embodiment, the step of applying the mixed solution on the substrate and the step of heating the substrate can be performed at the same time. In another embodiment, the substrate is heated first, and then the mixed solution is applied on the substrate afterwards. In an alternative embodiment, the mixed solution is applied on the substrate after the step of heating substrate is completed. In the embodiments, the substrate can be realized by such as a glass substrate, a ceramic substrate, or a metal substrate. However, in practical applications, the material of the substrate can be properly selected according to actual needs and is not limited to the above exemplifications.

In an embodiment, the mixed solution is sprayed on the substrate by such as a spraying process. In a spraying process, the mixed solution is atomized to form a spray, the spray along with a carrier gas is sprayed towards the substrate and then decomposed by heat and deposited on the substrate. In the embodiment, the mixed solution is atomized such as by way of ultrasonic atomization, the mixed solution is sprayed on the substrate through an ultrasonic nozzle in the form of atomized droplets, which is helpful in controlling the size and distribution of the droplets. In other embodiments, the mixed solution can be atomized through a pneumatic nozzle.

When the tin source and oxygen are separately fed to the reaction cavity to form a tin oxide film on the substrate, for example by adopting a chemical vapor deposition (CVD) process, it would be difficult to control the concentration ratio of the tin source to oxygen while reacting on the substrate. Moreover, since oxygen is introduced into the entire reaction cavity, it is not easy to assure whether the concentration of oxygen on the surface of the substrate is sufficient or not in the initial stage of reaction.

On the contrary, in the embodiments of the present disclosure, the mixed solution contains the tin source and the oxidizing agent which both are dissolved in a solvent. Since the tin source and the oxidizing agent are mixed together and applied on the surface of the substrate at the same time, the concentration ratio of the tin source to oxygen while reacting on the substrate can be more easily and precisely controlled, and the reaction conditions can be more effectively controlled.

Accordingly, the chance of nucleation of tin oxide film on the surface of the substrate is enhanced, which is helpful in controlling the grain sizes of the tin oxide film and forming a (200) lattice plane preferred orientation of the tin oxide film, thereby achieving the formation of the tin oxide film having low haze.

Moreover, in the embodiments of the present disclosure, since the concentration of the oxidizing agent on the surface of the substrate is high at the initial stage of reaction, many nucleation sites can be formed on the surface of the substrate. With grain growths occurring in many nucleation sites simultaneously, the grain sizes can be relatively small, the tin oxide film 10 can have a low haze (such as lower than 3%). In an embodiment, a tin oxide film having low haze can be quickly formed without adding any additives to suppress grain growths during the reaction process or performing any surface treatment on the tin oxide film. In another embodiment, additives for suppressing grain growths can be added according to actual needs, or a surface treatment can be additionally performed on the tin oxide film.

If oxygen and the tin source are separately fed to form the tin oxide film, due to the uprising air on the heated surface of the substrate, oxygen is very likely to be dispersed away from the substrate and can hardly be gathered on the surface of the substrate, resulting in low concentration of oxygen on the substrate surface, which is disadvantageous to the nucleation in subsequent process and the formation of the tin oxide film having low haze.

In the embodiments, the mixed solution may further include a dopant. In an embodiment, the dopant is such as ammonium fluoride (NH₄F), the tin source is such as a tin-containing compound, and the formed tin oxide film is such as a fluorine-doped tin oxide film (FTO). In an embodiment, the dopant may be such as ammonium fluoride and lithium chloride (LiCl), and the formed tin oxide film is such as a lithium-fluorine-doped tin oxide film (LFTO).

According to another embodiment of the present disclosure, a method of increasing the resistance of the tin oxide film is provided. The method of controlling the resistance of the tin oxide film includes: providing a mixed solution and a substrate, wherein mixed solution includes a tin source, an oxidizing agent, and a solvent; heating the substrate; and applying the mixed solution on the substrate to form the tin oxide film on the substrate, wherein the molar ratio of the tin source to the oxidizing agent is 1:0.3 to 1:1.5.

According to a further embodiment of the present disclosure, a method of increasing the resistance stability of a heat-treated tin oxide film is provided. The method of increasing the resistance stability of a tin oxide film after processes with a heat treatment includes: providing a mixed solution and a substrate, wherein the mixed solution includes a tin source, an oxidizing agent, and a solvent; heating the substrate; and applying the mixed solution on the substrate to form the tin oxide film on the substrate, wherein the molar ratio of the tin source to the oxidizing agent is 1:0.3 to 1:1.5, and the resistance variation rate of the heat-treated tin oxide film is lower than 10%. Detailed descriptions are disclosed in a number of embodiments below. However, the disclosed embodiments are for explanatory and exemplary purpose only, not for limiting the implementation of the present disclosure.

(1) The processing steps of embodiments 1-2 and comparison examples 1-2 are as follows: after tin dichloride is dissolved in water, hydrogen peroxide with various molar ratios (referring to Table 1) is added thereto to form mixed solutions whose molar concentrations are 1 M. Then, air is used as a carrier gas with a flow rate of 20 L/min (in some embodiments, the suitable flow rate is about 5-25 L/min), and the prepared mixed solutions are sprayed on the substrate heated with a temperature of 450° C. and at a spraying rate of 7.5 M/min to form tin oxide (TO) films thereon (in some embodiments, the suitable spraying rate is about 0.5-15 M/min).

(2) The processing steps of comparison example 3-4 are as follows: tin dichloride is dissolved in ethanol to form a tin dichloride ethanol solution whose molar concentration is 1 M. Then, oxygen is used as an oxidizing agent and a carrier gas with a flow rate of 20 L/min, and the tin dichloride ethanol solution and oxygen are sprayed on the substrate heated with a temperature of 450° C. and at various spraying rates (referring to Table 2), allowing tin dichloride to react with oxygen to form tin oxide films on the substrate.

TABLE 1

| | Surface | Film | | | Tin dichloride:hy- |
|---|---|---|---|---|---|
| | roughness | thickness | T1/ | Haze | drogen peroxide |
| | T1 (nm) | T2 (nm) | T2 | (%) | (molar ratio) |
| Embodiment 1 | 15.1 | 297.6 | 0.051 | 0.41 | 1:1 |
| Embodiment 2 | 15.8 | 293.7 | 0.054 | 1.31 | 1:0.3 |
| Comp. ex. 1 | 10.15 | 195.2 | 0.052 | 5.03 | 1:0.15 |
| Comp. ex. 2 | 16.70 | 192.7 | 0.087 | 18.75 | 1:0 |

Comp. ex.: Comparison example

TABLE 2

| | Surface | Film | | | Spraying |
|---|---|---|---|---|---|
| | roughness | thickness | T1/ | Haze | rate |
| | T1 (nm) | T2 (nm) | T2 | (%) | (M/min) |
| Comp. ex. 3 | 13.2 | 98.75 | 0.13 | 5.50 | 7.5 |
| Comp. ex. 4 | 30.1 | 395.68 | 0.076 | 8.65 | 1.6 |

(3) The processing steps of embodiments 3-5 and comparison examples 5-6 are as follows: tin dichloride and ammonium fluoride are dissolved in water, wherein the molar ratio of tin dichloride to ammonium fluoride is 1:0.3. Next, hydrogen peroxide with various molar ratios (referring to Table 3) is added thereto to form mixed solutions with a molar concentration of tin dichloride being 1 M. Then, air is used as a carrier gas with a flow rate of 20 L/min, and the prepared mixed solutions are sprayed on the substrate heated with a temperature of 500° C. and at a spraying rate of 2.5 M/min to form fluorine-doped tin oxide films thereon.

TABLE 3

| | Surface | Film | | | Tin dichloride:hy- |
|---|---|---|---|---|---|
| | roughness | thickness | T1/ | Haze | drogen peroxide |
| | T1 (nm) | T2 (nm) | T2 | (%) | (molar ratio) |
| Embodiment 3 | 17.1 | 325.2 | 0.053 | 2.36 | 1:1 |
| Embodiment 4 | 15.4 | 273.7 | 0.056 | 2.27 | 1:1.2 |
| Embodiment 5 | 15.1 | 296.2 | 0.051 | 1.47 | 1:1.5 |
| Comp. ex. 5 | 17.9 | 334.6 | 0.053 | 3.51 | 1:0.2 |
| Comp. ex. 6 | 19.2 | 230.3 | 0.083 | 4.18 | 1:0.15 |

(4) The processing steps of embodiments 6-8 and comparison examples 7-9 are as follows: tin dichloride, ammonium fluoride and lithium chloride are dissolved in water, wherein the molar ratio of tin dichloride, ammonium fluoride to lithium chloride is 1:0.5:0.03. Next, hydrogen peroxide with various molar ratios (referring to Table 4) is added thereto to form mixed solutions with a molar concentration of 1 M. Then, air is used as a carrier gas with a flow rate of 20 L/min, and the prepared mixed solutions are sprayed on the substrate heated with a temperature of 430° C. and at a spraying rate of 5 M/min to form lithium-fluorine-doped tin oxide films.

TABLE 4

| | Surface | Film | | | Tin dichloride:hy- |
|---|---|---|---|---|---|
| | roughness | thickness | T1/ | Haze | drogen peroxide |
| | T1 (nm) | T2 (nm) | T2 | (%) | (molar ratio) |
| Embodiment 6 | 15.1 | 297.6 | 0.051 | 0.42 | 1:0.6 |
| Embodiment 7 | 11.6 | 133.2 | 0.087 | 0.23 | 1:1.2 |
| Embodiment 8 | 11.6 | 141.0 | 0.082 | 0.28 | 1:1 |
| Comp. ex. 7 | 21.7 | 383.3 | 0.054 | 10.68 | 1:0.25 |
| Comp. ex. 8 | 40.5 | 327.8 | 0.124 | 5.54 | 1:0.1 |
| Comp. ex. 9 | 30.2 | 319.2 | 0.095 | 21.55 | 1:0 |

As indicated in comparison examples 3-4 in Table 2, the tin oxide films formed by reacting oxygen with the tin dichloride ethanol solution have haze of above 5.5%. On the contrary, the tin oxide films formed by spraying a mixed solution on the substrate according to the embodiments 1-2 of the present disclosure have haze of below 1.31%.

Moreover, as indicated in the comparison examples 1-2 and 5-9 in Tables 1-4, the molar ratio of tin dichloride to hydrogen peroxide in the mixed solution is 1:0-1:0.25, and the as-formed tin oxide films have haze of above 3.51%. On the contrary, the molar ratio of tin dichloride to hydrogen peroxide in the mixed solution according to the embodiments 1-8 of the present disclosure is 1:0.3-1:1.5, and the as-formed tin oxide films have haze of below 2.36%.

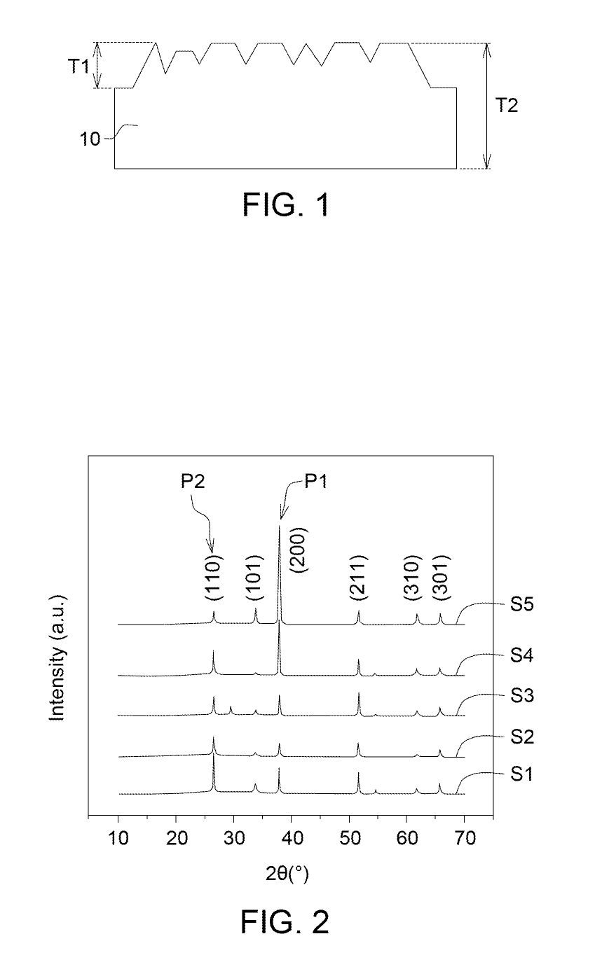

FIG. 1 is a schematic diagram of a tin oxide film according to an embodiment of the disclosure. As indicated in FIG. 1, the tin oxide film 10 has a film thickness T2 and a surface roughness T1, wherein the surface roughness T1 is a root mean square surface roughness (RMS surface roughness). In the embodiments as shown in Tables 1-4, the ratio of the surface roughness T1 to the film thickness T2 is such as greater than 0.05, and the tin oxide film 10 has a haze of such as lower than 3%. In the above embodiments, the ratio of the surface roughness T1 to the film thickness T2 is about 0.05-0.12. In other words, in the embodiments of the present disclosure, even when the surface of the tin oxide film 10 has a relatively large roughness, the tin oxide film 10 still has low haze (the haze with respect to visible light is lower than 3%).

FIG. 2 is an X-ray diffraction spectrum of a tin oxide film according to an embodiment of the disclosure. As indicated in FIG. 2, spectra S1, S2, S3, S4 and S5 respectively are the X-ray diffraction spectrum of the tin oxide films in comparison example 9, comparison example 8, comparison example 7, embodiment 6, and embodiment 7. Each of the spectra S1-S5 has a (200) diffraction peak P1 and a (110) diffraction peak P2 of tin oxide. In the embodiment, the integrated area of the (200) diffraction peak P1 is greater than the integrated area of the (110) diffraction peak P2. In the embodiment, the ratio of the integrated area of the (200) diffraction peak P1 to the integrated area of the (110) diffraction peak P2 is greater than 1.5 (referring to Table 5). That is, in the embodiment, the grains of the tin oxide film have a (200) lattice plane preferred orientation.

TABLE 5

| | Ratio of the integrated areas | |
|---|---|---|
| | of diffraction peaks P1/P2 | Haze (%) |
| S1 (comp. ex. 9) | 0.25 | 21.55 |
| S2 (comp. ex. 7) | 0.75 | 10.68 |
| S3 (comp. ex. 8) | 1.11 | 5.54 |
| S4 (embodiment 6) | 1.53 | 0.42 |
| S5 (embodiment 7) | 3.42 | 0.23 |

Refer to Table 6. Table 6 illustrates the sheet resistance of the tin oxide film in embodiments 9-11 and comparison examples 10-12.

The processing steps of embodiments 9-11 and comparison examples 10-12 are as follows: tin source is dissolved in ethanol, and hydrogen peroxide with various molar ratios (referring to Table 6) is added thereto to form mixed solutions with a molar concentration of 0.1 M. Then, air is used as a carrier gas with a flow rate of 20 L/min, and the prepared mixed solutions are sprayed on the substrate heated with a temperature of 450° C. and at a spraying rate of 0.6 M/min to form tin oxide (TO) films thereon.

TABLE 6

| | | Sheet | Tin source:hy- |
|---|---|---|---|
| | | resistance | drogen peroxide |
| | Tin source | (Ω/□) | (molar ratio) |
| Embodiment 9 | Tin dichloride | 5.42E+05 | 1:0.5 |
| Embodiment 10 | Tin Tetrachloride | 4.59E+06 | 1:1 |
| Embodiment 11 | Tetramethyltin | 5.36E+04 | 1:0.3 |
| Comp. ex. 10 | Tin dichloride | 8.32E+03 | 1:0 |
| Comp. ex. 11 | Tin tetrachloride | 1.32E+04 | 1:0 |
| Comp. ex. 12 | Tetramethyltin | 5.65E+03 | 1:0 |

As indicated in Table 6, when different tin sources are used, the sheet resistance of the tin oxide films in embodiments 9-11 is higher than the sheet resistance of the tin oxide films in comparison examples 10-12 respectively. In other words, the tin oxide film formed by a mixed solution containing the tin source and hydrogen peroxide according to the embodiments of the present disclosure is capable of increasing sheet resistance, and the tin oxide film with the feature of an increased sheet resistance can be used in gas detectors, transparent conductive films, and other applications requiring a transparent and semi-conductive film.

Refer to Table 7. Table 7 illustrates the resistance variation rate of the tin oxide films before and after a heat treatment according to embodiments 10-14 and comparison example 11.

The processing steps of embodiments 12-14 are as follows: tin tetrachloride is dissolved in ethanol, and hydrogen peroxide with various molar ratios (referring to Table 7) is added thereto to form mixed solutions with a molar concentration of 0.1 M. Then, air is used as a carrier gas with a flow rate of 20 L/min, and the prepared mixed solutions are sprayed on the substrate heated with a temperature of 450° C. and at a spraying rate of 0.6 M/min to from tin oxide (TO) films. Then, after a heat treatment is performed on the tin oxide films at a temperature of 500° C. for 10 minutes, the resistance of the tin oxide films before and after the heat treatment is measured. The variation rate is a percentage of the variation in resistance (the variation in resistance before and after a heat treatment) to the original resistance.

TABLE 7

| | Sheet | | Tin source:hy- |
|---|---|---|---|
| | resistance | Variation | drogen peroxide |
| | (Ω/□) | rate (%) | (molar ratio) |
| Embodiment 10 | 4.59E+06 | 1.56 | 1:1 |
| Embodiment 12 | 3.25E+06 | 6.94 | 1:0.3 |
| Embodiment 13 | 4.37E+06 | 2.92 | 1:0.5 |
| Embodiment 14 | 4.81E+06 | 1.13 | 1:1.5 |
| Comp. ex. 11 | 1.32E+04 | 10 | 1:0 |

As indicated in Table 7, the variation rates of sheet resistance of the formed tin oxide films processed with a heat treatment according to embodiments 10-14 are lower than that of the tin oxide film in comparison example 11. That is, in embodiments 10-14 of the present disclosure, the molar ratio of the tin source to the oxidizing agent is 1:0.3 to 1:1.5, the variation rates of sheet resistance of the tin oxide film are processed with a heat treatment can be controlled to be lower than 10%. Moreover, the smaller the molar ratio of tin tetrachloride (tin source) to hydrogen peroxide (the oxidizing agent) is, the smaller the variation rates of the sheet resistance would be. For example, as indicated in embodiment 14, when the molar ratio of tin tetrachloride to hydrogen peroxide is 1:1.5, the variation rate of the sheet resistance is 1.13%. The low variation rate of sheet resistance is good for temperature tolerance in the manufacturing process of electronic elements.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A manufacturing method of a tin oxide film, comprising:
providing a mixed solution and a substrate, wherein the mixed solution comprises a tin source, an oxidizing agent and a solvent;
heating the substrate; and
applying the mixed solution on the substrate to form the tin oxide film on the substrate.

2. The manufacturing method of the tin oxide film according to claim 1, wherein the tin source comprises at least one of tin dichloride, tin tetrachloride, butyltin trichloride, dimethyltin dichloride, and tetramethyltin.

3. The manufacturing method of the tin oxide film according to claim 1, wherein the oxidizing agent comprises at least one of hydrogen peroxide and hypochlorous acid.

4. The manufacturing method of the tin oxide film according to claim 1, wherein a molar ratio of the tin source to the oxidizing agent is 1:0.3 to 1:1.5.

5. The manufacturing method of the tin oxide film according to claim 1, wherein the mixed solution further comprises ammonium fluoride.

6. The manufacturing method of the tin oxide film according to claim 1, wherein the mixed solution further comprises lithium chloride.

7. The manufacturing method of the tin oxide film according to claim 1, wherein the tin oxide film comprises at least one of tin oxide, fluorine-doped tin oxide, and lithium-fluorine-doped tin oxide.

8. The manufacturing method of the tin oxide film according to claim 4, wherein the manufacturing method is used for increasing resistance of the tin oxide film.

9. The manufacturing method of the tin oxide film according to claim 4, wherein the manufacturing method is used for increasing resistance stability of the tin oxide film after processed with a heat treatment, and the tin oxide film after processed with the heat treatment has a resistance variation rate of lower than 10%.

10. A tin oxide film, wherein the tin oxide film has a haze with respect to visible light of lower than 3%, a film thickness, and a surface roughness, the surface roughness is a root mean square (RMS) surface roughness, and a ratio of the surface roughness to the film thickness is greater than 0.05.

11. The tin oxide film according to claim 10, wherein grains of the tin oxide film have a (200) lattice plane preferred orientation.

12. The tin oxide film according to claim 10, comprising at least one of tin oxide, fluorine-doped tin oxide, and lithium-fluorine-doped tin oxide.

13. A tin oxide film, wherein the tin oxide film has a haze with respect to visible light of lower than 3%, the X-ray diffraction spectrum of the tin oxide film has a (200) diffraction peak and a (110) diffraction peak of tin oxide, and a ratio of the integrated area of the (200) diffraction peak to the integrated area of the (110) diffraction peak is greater than 1.5.

14. The tin oxide film according to claim 13, comprising at least one of tin oxide, fluorine-doped tin oxide, and lithium-fluorine-doped tin oxide.
